(19) United States
(12) Patent Application Publication
(10) Pub. No.: US 2011/0029513 A1
(43) Pub. Date: Feb. 3, 2011

(54) Method for Determining Document Relevance

(76) Inventor: Stephen Timothy Morris, Abingdon (GB)

Correspondence Address: MCDONNELL BOEHNEN HULBERT & BERGHOFF LLP, 300 S. WACKER DRIVE, 32ND FLOOR, CHICAGO, IL, 60606, US

(21) Appl. No.: 12/845,688

(22) Filed: Jul. 28, 2010

(30) Foreign Application Priority Data
Jul. 31, 2009 (GB) 0913305.9

(51) Int. Cl. G06F 17/30

(52) U.S. Cl. 707/728; 707/E17.014

(57) ABSTRACT

The relevance of a document to a given word or phrase is determined by calculating a function of whether the word or phrase occurs in the document and whether each member of a set of words or phrases related to the given word or phrase occurs in the document. A phrases may be included in this set if, out of all the documents in a collection that contain all the words of the phrase, the proportion of documents containing the phrase is greater than a predetermined value. Document relevance can be used to search for a document.

### CROSS-REFERENCE TO RELATED APPLICATIONS

The present application claims priority to Great Britain Patent Application GB 0913305.9 filed in the GB Patent Office on Jul. 31, 2009, the entire contents of which is incorporated herein by reference.

### BACKGROUND

This invention relates to the field of computer-implemented processing of text; in some preferred embodiments it relates to searching for documents on the World Wide Web.

It is known to receive a search query and to perform a computer-implemented search for documents relating to that search query. Various different algorithms have been proposed for this with the goal of returning a document, or set of documents, that a human observer would consider to be a good match for the search query. Such computer-assisted document searching is useful in many areas, such as searching for documents stored on the hard-drive of a personal computer, but is perhaps most famous in the context of searching for documents, especially HTML documents, on the World Wide Web.

Presently known search engines and algorithms, however, do not always succeed in returning particularly appropriate content. This may be especially obvious when a human user enters a search term consisting of several words or phrases. This is likely to be a familiar experience to anyone who has used existing search engines extensively.

Early search engines used a very simple approach to ranking documents on the World Wide Web: they assessed the relevance of a document to a key word or phrase by counting the number of times that word or phrase appeared in the document. This approach relied on two things: first that the number of documents that are relevant to any given topic is small (the principle of scarcity), so that any one of them can be considered to be as reliable as any other; and secondly, that content providers do not try to artificially promote their documents to the top of a results list by, for example, adding keywords to a document in order for it to appear more relevant even though the usefulness of the document to the human searcher is not increased.

Later, as the number of documents grew, and as content providers began to try artificially to promote their documents by adding keywords, such an approach became much less useful. The problems of an abundance of candidate documents and of artificial promotion were addressed by the introduction of search engines implementing a notion of document “authority”. Search engines calculate the “authority” of documents by measuring their link popularity (i.e. how many other documents link to the document of interest), and score documents based on a combination of relevance and authority.

However there are still problems with this approach. For example, a popular document such as the home page of a popular search engine may not contain the phrase “search engine” in the displayed text of the page, and so would not be considered relevant to this search phrase, even though it may be a highly popular document and a human would consider it to be highly relevant. Conversely, simply due to its popularity, the same page may be treated as authoritative for any text that the page does contain (such as a copyright notice), even though the document may be neither particularly relevant nor authoritative for such text.

More recently the descriptive text of a hyperlink has been used as an additional measure of relevance in an attempt to address some of these problems.

However, this approach is still open to the artificial promotion of documents by a publisher, for example, creating (or causing to be created) many links to a single document, causing that document to be ranked artificially much higher, even though the usefulness of the page to the searcher is not increased in this way.

This approach also has little in common with how a human assesses the relevance of a document. A human doesn't need to know anything about other documents or the structure of the links between documents in order to evaluate the relevance of a given document to a particular subject, whereas some popular search engine indexers expend most of their effort considering other documents, rather than the document in question. Nonetheless, determining the authority of a document is not an easy task for a human to perform, and determining the link popularity of documents can be an important component of determining authority.

Such an approach also fails to take into account additional factors, such as whether a particular Internet domain suffix (e.g. .gov or .edu) might be more appropriate for a particular type of search, or whether a particular domain name is authoritative for a given search.

It has been suggested, for example in U.S. Ser. No. 09/418418, to use a set of expert documents to calculate subject-specific authority. However, the use of a subset of expert documents limits the general applicability of the method.

The inventor has realised that a key reason for the under-performance of many known search engines and algorithms is that they do not have any mechanism corresponding to a human understanding of the meaning of the terms of a search query. Rather, they typically treat phrases as an ordered sequence of words, such that they seek literal matches to a search query. For example, the phrase “President of the United States” should be regarded as a phrase with specific meaning, rather than simply as a set of five words that frequently appear together in this exact word order. Furthermore, phrases such as “George Washington” and “Abraham Lincoln” may be related to the phrase “President of the United States” and so a document that contains these additional phrases should be considered to be a better match to a search for “President of the United States” than one that contained the search phrase only; these additional phrases may in fact constitute the information the searcher is looking for.

One approach to identifying phrases that encapsulate specific meaning rather than merely being sequences of words, has been proposed in US 20060031195, using a concept of “information gain”. The “information gain” of a word A in the presence of a word B is the co-occurrence rate of A and B divided by the expected co-occurrence rate if the words were not related. If the information gain is greater than some predetermined threshold, then the words are related and the presence of A in, for example, a document predicts the presence of B. The approach can be used to identify phrases, to quantify relationships between words and phrases, and to rank documents in an information retrieval system. However, it has several significant shortcomings including that it fails to identify certain types of phrases, and that it remains susceptible to artificial promotion of documents through the inclusion of repeated instances of key words or phrases within a document. It can fail to identify important phrases because it identifies phrases only if they appear in some distinguished way; e.g. in bold or as a hyperlink.

However, this approach will miss many phrases. For example, the phrase “opening times” may be related to phrases such as “open every day”, “closed on Mondays”, or “9 am to 5 pm”, but phrases such as these are unlikely to appear as distinguished text, and so they will not be found by the described approach, despite a document that contains such phrases potentially being relevant to the phrase “opening times”. The application of “information gain” to find related keywords implicitly assumes that if A predicts B then B predicts A, but this is not necessarily so. The disclosed method also detects phrases only if their frequency exceeds some predetermined threshold, and will therefore fail to find phrases that comprise rare words. It also selects only those documents that contain one or more of the phrases in a user's search query; however, this may exclude many relevant documents from consideration.

Another approach to trying to enable search engines to “understand” the words of the search query is that of latent semantic indexing; see, for example, U.S. Pat. No. 4,839,853. However such an approach is much more computationally demanding than conventional search engines. Furthermore, Latent Semantic Indexing typically has to make simplifications by disregarding common words such as “a” and “the”, and by applying stemming of words (e.g. disregarding the distinction between singular and plural nouns, or gerunds and infinitives of verbs); however such simplifications are highly undesirable, since they cause a significant information loss which may result in poor search performance

### SUMMARY

A computationally simpler approach is therefore required, which enables the meaning of words and phrases in a document and/or a search query to be harnessed to give an improved notion of document relevance.

Thus, from a first aspect, the invention provides a computer-implemented method of determining the relevance, to a given word or phrase, of a document from a collection of documents, the method comprising:

accessing a predetermined set of words and/or phrases that are related to the given word or phrase; and

calculating a document relevance score as a function of:
whether the word or phrase occurs in the document; and
for each word and phrase from the predetermined set, whether the related word or phrase occurs in the document.

The invention extends to corresponding data-processing apparatus configured to carry out said method; to a computer software product for programming such apparatus to carry out said method; and to a computer program comprising instructions that, when executed on data-processing apparatus, cause it to carry out said method. The computer program may be stored on a storage medium such as a CD, DVD, RAM or hard drive, or may be supplied as data from a remote location, for example by means of the Internet. The data-processing apparatus may be a single apparatus such as a server or may comprise a plurality of distinct processing means such as multiple servers on a network.

This contrasts with prior art approaches to determining relevance in which the number of times a word occurs in a document is considered. The inventor has recognised that such an approach is beneficial as it prevents a document that merely contains repetitive use of a word or phrase being given undue relevance over other documents for that word or phrase; on the contrary, the present invention recognises that it is the appearance in a document of many supporting concepts (indicated by the presence of interrelated words and phrases), rather than the repetition of any single concept, that best correlates with an intuitive human assessment of the relevance of a document to a given word or phrase. Indeed the most relevant document may not even contain the search word or phrase.

The determinations of whether the word or phrase, and related words or phrases, occur in the document may determine the value of a binary variable (e.g. the state of a one-bit electronic register) which is then used as an input to the function.

A phrase is a sequence of consecutive words. One method for extracting phrases from a document collection is presented below, but other methods may be used in this aspect of the invention as appropriate.

Preferably the calculated relevance score is stored in data storage means. Alternatively or additionally it may be transmitted to a search component for use in determining the results of a search query.

Preferably the predetermined set of words and/or phrases that are related to the given word or phrase is a database of words and/or phrases stored on a data retrieval apparatus. The set is preferably constructed by analysing a relatedness-analysis collection of documents. In preferred embodiments, this analysis is such that a first word or phrase appearing in the relatedness-analysis collection of documents is determined as being related to a second word or phrase according to a relatedness function of at least two of the following variables: the number of documents in the collection that contain both the first and second words or phrases; the number of documents that contain at least one of the first or second words or phrases; the number of documents that contain the first word or phrase; the number of documents that contain the second word or phrase; the number of documents that contain the first word or phrase but not the second word or phrase; and the number of documents that contain the second word or phrase but not the first word or phrase. The relatedness function preferably gives a real number as output.

Advantageously the relatedness function is not symmetric in the first and second words or phrases; i.e. a first word may be determined to be related to a second word, while the second word is not determined to be related to the first word. This allows the function better to reflect an intuitive human understanding of the relatedness of words or phrase within a document collection. For example, the presence of the word “cow” in a document may by a strong predictor for the presence of the word “the” in the same document, since “cow” implies a high chance that the document is written in English and “the” is a very common word in English documents; however the presence of the word “the” in a document is not a strong indicator for the presence of the word “cow”. Therefore, in some embodiments, it might be determined that “cow” is strongly related to “the”, but “the” is only weakly related to “cow”. Thus, in some embodiments, the relatedness function can be understood as representing the extent to which the presence of the first word or phrase in a document of the collection predicts the presence of the second word or phrase in the document; i.e. “A is strongly related to B” may, in some embodiments, be viewed as equivalent to “A strongly predicts B”.

In particularly preferred embodiments, the relatedness function is the number of documents in the relatedness-analysis collection containing both the first and second words or phrases divided by the number of documents in the collection containing the first word or phrase. Alternatively the relatedness function is the number of documents in the relatedness-analysis collection containing both the first and second words or phrases divided by the number of documents in the collection containing the first word or phrase but not the second. In some embodiments either or both of these definitions may be used variously whenever a relatedness function is required. Other relatedness functions may be used additionally or alternatively.

A binary determination of relatedness of a first word or phrase to a second word or phrase may be made according to whether the value of the relatedness function is greater than a predetermined value, this threshold preferably being between 0 and 1; more preferably between 0 and 0.5; and most preferably between 0 and 0.1; for example, 0.01.

In the aforementioned method, the document relevance score for the given word or phrase is preferably zero if the document contains neither the word or phrase nor any of the words or phrases from the predetermined set of words and/or phrases that are related to the given word or phrase.

Preferably the document relevance score is 1 if the document contains the word or phrase but none of the related words or phrases.

If the document does not contain the given word or phrase but does contain at least some of the related words or phrases, the document relevance score is preferably a function of how related each of the related words and/or phrases appearing in the document is to the given word or phrase. Particularly preferably it is the sum, over each of the related words and/or phrases appearing in the document, of the or a relatedness-function output for how strongly that related word and/or phrase relates to the given word or phrase.

If the document contains the given word or phrase as well as at least some of the related words or phrases, the document relevance score is preferably a function of:

the sum, U, over each of the related words and/or phrases appearing in the document, of the outputs of the or a relatedness function for how strongly the related word or phrase relates to the given word or phrase; and

the sum, V, over each of the related words and/or phrases appearing in the document, of the outputs of the or a relatedness function for how strongly the given word or phrase relates to the related word or phrase.

The relatedness function used in the calculation of U may be the same as that used in the calculation of V, but it need not necessarily be.

In some preferred embodiments, the document relevance score in this situation includes the term U+V. Particularly preferably, it equals 1+U+V. The inclusion of the term 1 in the score is advantageous as it ensures that the result is always at least as high as that for the case where only the word or phrase itself appears in the document (when the score is preferably exactly 1).

It will be understood that the precise calculations employed may be subject to variation in ways that do not depart from the spirit of the invention or which do not materially affect the outcome of the relative relevance scores for a plurality of documents; for example, changes in the calculations caused by scaling some or all of the terms by a linear factor, or stretching according to an exponential or other monotonic function, or shifting by a constant offset, or rounding, or other approximations, are all envisaged and fall within the scope of the invention.

In preferred embodiments, the method of determining the relevance, to a given word or phrase, of a document from a collection of documents further includes a step of searching for a document from among the collection of documents by:
receiving a search query comprising at least one word or phrase;
for each document in the collection of documents, calculating an aforesaid relevance score for the document against a word or phrase of the search query; and
using these relevance scores to determine a most relevant document from the collection of documents.

This collection of documents may be different from the relatedness-analysis collection of documents, but it is preferably the same, or substantially the same. It preferably comprises a collection of documents publicly available on the World Wide Web at a moment in time or over a period of time; particularly preferably, it comprises all, or substantially all, HTML documents publicly available on the World Wide Web. It may alternatively or additionally comprise formatted or unformatted text-containing documents in any non-HTML format, such as Adobe PDF (RTM) or Microsoft Word (RTM).

In some embodiments the notion of document extends to multimedia content such as images and videos having text associated therewith. This text may be extracted directly from the images or video through text recognition; or may be determined from the multimedia content by a computing device configured to analyse the content to determine meaning therefrom (e.g. automatically associating the word “flower” with a photograph of a flower); or from mark-up of text descriptions provided alongside the multimedia content (e.g. HTML mark-up description tag, or a paragraph of text adjacent a photograph). The method of the invention may then be adapted to treat the associated text as the document, and preferably to display or other transmit the associated multimedia content associated with the most relevant “document”.

In some embodiments, the relatedness-analysis document collections may comprise earlier versions of documents used for the relevance determination.

The search query may be received from input apparatus such as a keyboard or from another computing device such as a server.

The most relevant document and/or a hyperlink to the most relevant document and/or a reference to the document and/or information concerning the document and/or text extracted from the document may be displayed on a display device and/or may be sent as an electronic signal over a wire or network. Preferably the search query is received from a human user and an output from the system is given back to the human user in response. A relevant text extract from a document may be determined by splitting the document into text blocks, e.g. by splitting it between semantic markers such as punctuation, or other mark-up; determining a relevance score for each text block against at least one word or phrase of the search query; and returning the most relevant text block. The notion of text block may extend to multimedia content referenced by the document. Thus a relevant extract from a document may be determined by splitting the document into blocks; determining a relevance score for text associated with each block against at least one word or phrase of the search query; and further processing the most relevant block e.g. by outputting and/or displaying the block and/or a reference thereto and/or a link thereto and/or a multimedia object associated therewith.

The relevance scores may be used directly to determine a most relevant document by selecting the document having the highest relevance score. Alternatively, the relevance score may be combined with other factors to determine a most relevant document. In some preferred embodiments, the method comprises calculating one or more additional relevance scores for a document, such as a document title relevance score, a document body-text relevance score, a domain-name relevance score (relating to the domain name of an Internet server hosting the document), or a URL relevance score. These may be calculated in a similar manner to the document relevance score—e.g. by considering the domain name to be a “document” in its own right in the foregoing method steps.

A measure of the likelihood that a document containing a given word or phrase is hosted at a given Internet domain extension may also be used to determine a further indicator of relevance of a document to a search word or phrase by considering the domain extension of the server hosting that document.

Where the search query comprises a plurality of words and/or phrases, the method may comprise the further step of, for each document in the collection of documents, calculating an aforesaid relevance score for the document against a plurality of words and/or phrases of the search query. These relevance scores may be combined in any appropriate manner to determine a most relevant document. In some embodiments, calculation of an overall relevance score for a document includes the step of multiplying together the relevance scores for each of the plurality of words and/or phrases of the search query. Alternatively, further processing may be applied to each relevance score and the results of this processing for a given document may be combined, for example, by multiplication, across each of the plurality of words and/or phrases of the search query.

When searching for a document, one or more of these additional relevance scores may be calculated for some or all documents in the collection; these additional relevance scores may be used to determine a most relevant document from the collection of documents. They may, for example, be multiplied together to obtain an overall relevance score for a document; alternatively they may be added together to obtain an overall relevance score for a document; or combined according to some other function.

In preferred embodiments, the method of determining the relevance, to a given word or phrase, of a document from a collection of documents comprises a further step of determining a thematic-content score for the document as a function of the relevance scores of the document for each word and phrase of a predetermined set of words and phrases.

Preferably the thematic-content score is the sum of the relevance scores of the document for each word and phrase of a predetermined set of words and phrases. The predetermined set of words and phrases preferably comprises all words occurring in the collection of documents; it preferably further comprises all phrases occurring in the collection of documents according to some predetermined definition of a phrase or phrase-finding algorithm. One such phrase-finding algorithm is described herein, but others may be used as appropriate. Alternatively or additionally the predetermined set of words and phrases may be defined with respect to a phrase-analysis document collection, not necessarily being the same as the aforesaid document collection.

The thematic-content score thus captures the extent to which the words of the document are mutually related. Informally, it will be understood that the thematic-content score of a document therefore corresponds to an intuitive human notion of the extent to which a document provides non-trivial content around one or more themes; as opposed to a document which contains largely random text or which touches only superficially on various different subjects. This notion of a thematic-content score can therefore be useful in providing a user with documents that are likely to be relatively informative on a subject of interest.

The method of the invention may be further extended to determine a thematic-content score for a document sub-collection e.g. all the HTML pages hosted on a particular Internet domain or server. Thus, in preferred embodiments, the method further comprises determining a thematic-content score for a document sub-collection as a function of the thematic-content scores of every document in the sub-collection. The thematic-content score of a sub-collection may be calculated as the average (e.g. mean or median) document thematic-content score for the sub-collection.

In some embodiments, the document relevance score or overall document relevance score may be modified by the thematic-content score of the document and/or the thematic-content score of a document sub-collection of which it is a member. For example, the two scores may be multiplied together to obtain a modified document score.

In addition to determining a most relevant document, methods of the invention may also determine a list of relevant documents, some or all of which may be displayed or otherwise transmitted to a user. The list is preferably ordered according to overall document relevance score, or a function of document relevance score and one or more other factors such as document thematic-content score and/or an overall document relevance score and/or a sub-collection thematic-content score and/or a document authority score.

Methods of the invention may also comprise a step of determining a document authority score for a document and a given word or phrase, the authority score being a function of: the relevance of the document to the word or phrase; the relevance, to the word or phrase, of a referring document that contains a reference to the first document; and the relevance, to the word or phrase, of text forming all or part of said reference. The function preferably also takes as an argument the total number of references to other documents contained in the referring document and/or the popularity of the referring document.

In some preferred embodiments, a document authority score is the relevance of the document to the word or phrase multiplied by the sum of: the relevance scores, to the word or phrase, of each referring document that contains a reference to the first document, multiplied by the relevance score, to the word or phrase, of the referring text, divided by the total number of references to other documents contained in the respective referring document, and multiplied by the popularity of the referring document.

Preferably an overall document authority score is obtained as a function (e.g. the product or sum) of the document authority scores for each of a predetermined set of words and phrases. The overall document authority score may also be a function of the document relevance and/or document authority scores.

A reference to a document may be a hyperlink or any other active or passive reference to the document in question where the reference comprises text.

The method of determining the relevance, to a given word or phrase, of a document from a collection of documents may further comprise the step of outputting a summarising word or phrase for the document by calculating the document relevance score or authority score for each word and phrase of a predetermined set of words and phrases; determining the word or phrase having the highest relevance score; and outputting this word or phrase. An additional summarising word or phrase having the second-highest relevance score may also be output; similarly for the third-highest, etc. Words and/or phrases related to one or more summarising words or phrases may also be output. The output may be used to determine an advertisement related to the output word(s) or phrase(s) and the method may comprise the further step of display or transmitting said advertisement.

In one embodiment, the summarising word or phrase may be used to extract a query-independent text extract from a document by determining the text block that is most relevant to the summarising word or phrase.

From a second aspect the invention provides a computer-implemented method of building a database of phrases occurring in a phrase-analysis document collection, comprising, for each of a plurality of sequences of consecutive words:
determining whether, out of all the documents in the collection that contain all the words of the sequence, the proportion of documents containing the sequence consecutively is greater than a predetermined value; and
including the sequence in the database only if said determination is made.

The invention extends to corresponding data-processing apparatus configured to carry out said method; to a computer software product for programming such apparatus to carry out said method; and to a computer program comprising instructions that, when executed on data-processing apparatus, cause it to carry out said method. The computer program may be stored on a storage medium such as a CD, DVD, RAM or hard drive, or may be supplied as data from a remote location, for example by means of the Internet. The data-processing apparatus may be a single apparatus such as a server or may comprise a plurality of distinct processing means such as multiple servers on a network.

Preferably the sequence is included in the database only if, additionally, at least one of the words of the sequence is semantically related to all of the other words of the sequence. Preferably the sequence is positively included in the database whenever both of the foregoing conditions are met. Semantic relatedness may be determined according to any appropriate measure. In some preferred embodiments, a first word is considered to be semantically related to a second word if, out of all the documents in the collection that contain the first word, the proportion of documents containing both words is greater than a predetermined value.

The phrase-analysis collection of documents may be different from the relatedness-analysis collection of documents, but it is preferably the same, or substantially the same. It preferably comprises a collection of documents publicly available on the World Wide Web at a moment in time or over a period of time; particularly preferably, it comprises all, or substantially all, HTML documents publicly available on the World Wide Web. It may alternatively or additionally comprise formatted or unformatted text-containing documents in any non-HTML format, such as Adobe PDF (RTM) or Microsoft Word (RTM). In some embodiments, the relatedness-analysis document collections may comprise earlier versions of documents used for the relevance determination.

The plurality of sequences of consecutive words may comprise all possible sequences of all the words occurring in the phrase-analysis collection, or of all the words occurring, for each sequence, in at least one document of the phrase-analysis collection. Preferably, though, the plurality of sequences of consecutive words comprises all possible sequences of words that are related to one another according to an appropriate measure of relatedness, such as one defined herein.

Preferably the plurality of sequences of consecutive words includes a sequence of length n words only if the sequence contains a sub-sequence of length n−1 that is already in the database (i.e. has previously been identified as a phrase). This can provide a substantial efficiency saving.

Preferably the plurality of sequences of consecutive words does not include sequences that appear substantially always as sub-sequences of other sequences. Preferably, a sequence is not included if the number of documents in which the sequence occurs, divided by the number of documents containing sequences that contain the aforesaid sequence as a sub-sequence, is less than a predetermined value, the value preferably being greater than 1; more preferably being between 1 and 2; for example 1.1.

The method may further comprise the step of, for each of a plurality of the documents in the phrase-analysis document collection, parsing the document to generate a tokenised version in which phrases and words in the document are replaced by tokens. Preferably the longest phrases are replaced by tokens first, followed by successively shorter phrases, and finally any remaining words are tokenised. This parsing may be preceded by a text-extraction step in which text is extracted from other text or from control data such as HTML tags contained in the original document.

The method may further comprise the steps of:

receiving a text query;

for at least one word from the text query, accessing the database to determine a list of phrases starting with that word; and

displaying or transmitting one of the list of phrases.

In this way, the method may be used as a search query completion mechanism, suggesting a possible search query phrase to a user of a search engine before the user has typed the full intended search phrase. More than one of the list of phrases may be displayed or transmitted, and these are preferably sorted by an appropriate measure of popularity or frequency of occurrence within a document collection.

Additionally or alternatively, the method may comprise the further steps of:

receiving a text query;

determining a list of words and phrases related to the text query;

selecting one or more entries from said list of words and phrases;

displaying or transmitting the selected entry or entries to a user.

The selected entry or entries are preferably the most common word or phrase out the list of related words and phrases, as determined by popularity or any other suitable measure including those explained herein. In this way possible alternative related search queries may be suggested to a user. A similar approach may also be used to suggest a corrected text query when the input text query contains a typographic mistake such as a misspelled word.

Various aspects and optional features of the invention have been described in various combinations. However it is to be understood that the invention is not limited just to such combinations but that any of the above-described features may, where appropriate, be applied in any suitable combination to any of the above-described aspects of the invention.

### BRIEF DESCRIPTION OF THE DRAWINGS

Certain preferred embodiments of the invention will now be described, by way of example only, with reference to the accompanying drawings, in which:

FIG. 1 schematically shows a system architecture suitable for implementing an embodiment of the invention;

FIG. 2 is a flow chart of steps performed by an embodiment of the invention;

FIG. 3 is a Venn diagram for explaining the derivation of an algorithm of the embodiment;

FIG. 4 is a Venn diagram for explaining the derivation of an algorithm of the embodiment;

FIG. 5 is pseudo-code showing an implementation of an algorithm of the embodiment;

FIG. 6 is pseudo-code showing an implementation of an algorithm of the embodiment;

FIG. 7 is a Venn diagram for explaining the derivation of an algorithm of the embodiment;

FIG. 8 is a Venn diagram for explaining the derivation of an algorithm of the embodiment;

FIG. 9 is a Venn diagram for explaining the derivation of an algorithm of the embodiment;

FIG. 10 is pseudo-code showing an implementation of an algorithm of the embodiment;

FIG. 11 is pseudo-code showing an implementation of an algorithm of the embodiment;

FIG. 12 is pseudo-code showing an implementation of an algorithm of the embodiment; and

FIG. 13 is a flow chart of steps performed by an embodiment of the invention.

### DETAILED DESCRIPTION

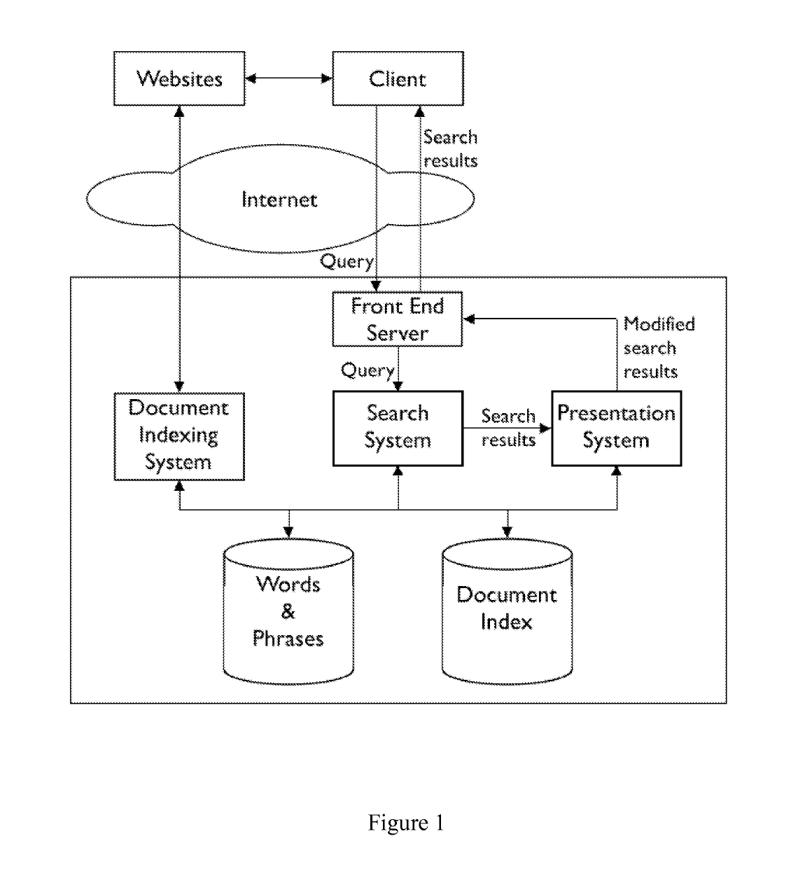

FIG. 1 shows the software architecture of the overall system suitable for implementing an embodiment of the present invention. The overall system includes a Document Indexing System, a Search System, a Presentation System and a Front End Server.

The Document Indexing System identifies words and phrases within the document collection, calculates quantities that measure their degree of relatedness, calculates the relevance, authority and score of every document in the collection for every identified word and phrase, and stores this information for use by the Search System and Presentation System. Additionally it determines the primary topic of every document in the collection. The Document Indexing System involves the collection and processing of a vast quantity of data, and it is not envisaged that it would run in real time.

The Search System parses the search query for words and phrases, calculates an overall score for every document in the collection, and sorts the results by score.

The Presentation System generates a rich multimedia description of each document, tailored to the specific search query.

The Front End Server receives a search query from a user, sends this query to the Search System and displays the search results provided by the Search System and Presentation System to the user.

The Front End Server, Search System and Presentation System are designed to be fast systems capable of handling large numbers of searches every second.

The System also includes an ordered list of words and phrases, plus quantities that measure their degree of relatedness. It also includes a Document Index containing for each document in the collection information such as the raw HTML content, the textual content in terms of recognised words and phrases, URL's, domains, relevances, scores and primary topics.

### Document Indexing System

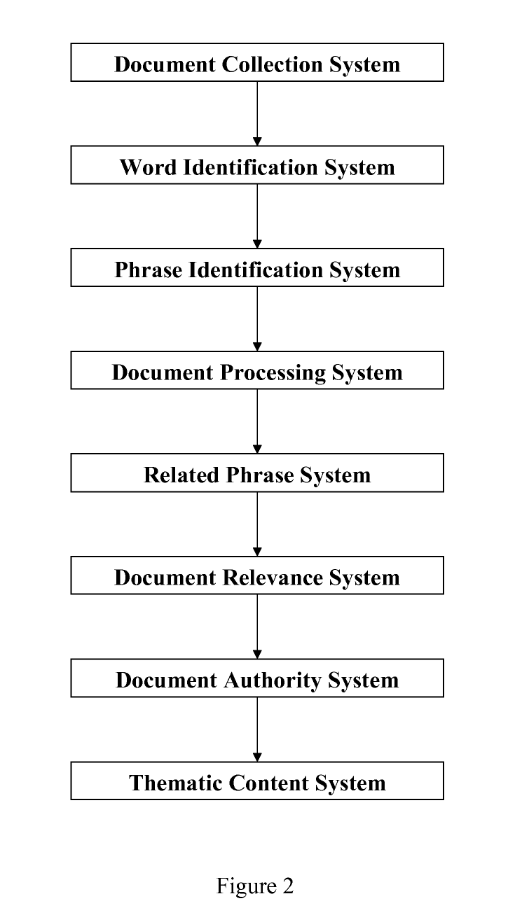

FIG. 2 shows the components of the Document Indexing System in the order in which they are employed when indexing documents. Such indexing may be carried out just once, intermittently, continually or continuously. The key components of the Document Indexing System are: a Document Collection System that crawls the World Wide Web and saves the documents in the Document Index; a Word Identification System that finds all words in the document collection; a Phrase Identification System that identifies all phrases; a Document Processing System that splits document text into its constituent words and phrases; a Related Phrase System

that finds the words and phrases that are related and calculates the αᵢ and βᵢ relatedness parameters for each; a Document Relevance System that calculates the relevance of every document to every possible search word and phrase; a Document Authority System that calculates the authority of every document to every possible search word and phrase; and a Thematic Content System that calculates the thematic content score of every document, and hence the thematic content score of every domain.

These various components will now be described in more detail.

### Document Collection System

The Document Collection System crawls the World Wide Web and saves the documents in the Document Index.

### Word Identification System

First a list of all unique words that appear in the document collection is identified. A word is any sequence of printable characters that is separated from other words by a character such as a space, comma, question mark, etc., or by mark-up tags (HTML, XML, etc.) The System saves the list of words, converted to lower case and ordered such that the most common words appear at the beginning. This will speed up access of words in the list.

### Phrase Identification System

The Phrase Identification System identifies phrases that appear in the document collection. A phrase is a sequence of two or more words that are related (i.e. appear in the same documents frequently compared with their separate appearances) and that appear in an exact order frequently in the documents in which they appear together. A phrase may consist of many words, e.g. “a rose by any other name would smell as sweet.”

The System will insert “break” tokens between words that are separated by mark-up tags that mark the start or end of headings, paragraphs or other semantic structures. This prevents incorrect detection of phrases that are split between semantic elements.

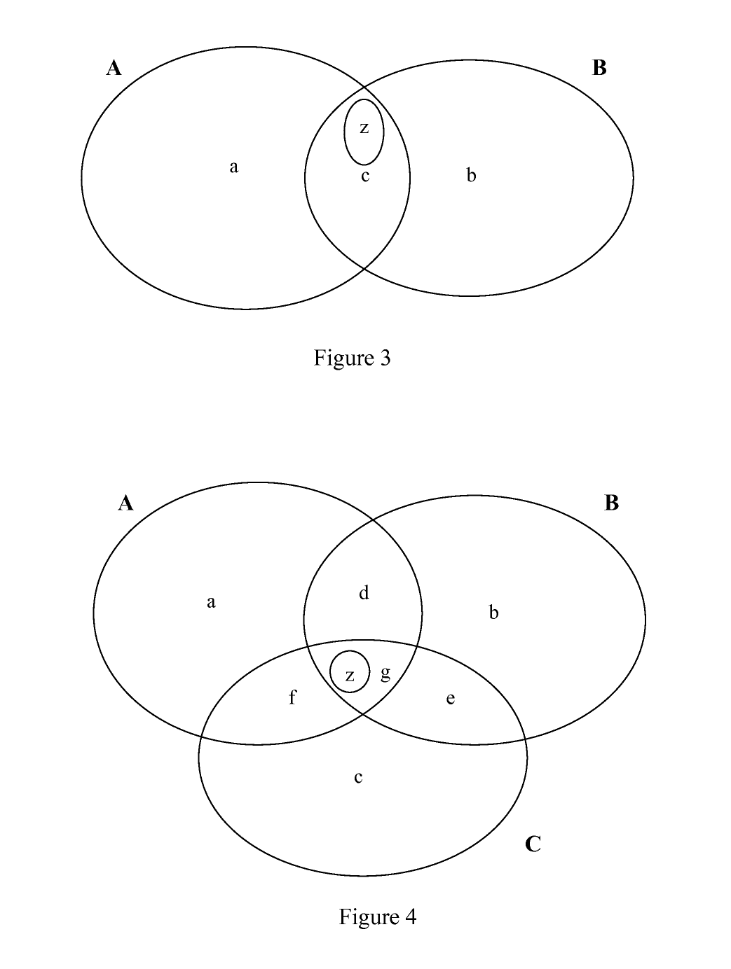

The method for determining related words (and hence phrases) is motivated by the following analysis. Consider two words A and B. The Venn diagram in FIG. 3 shows the sets of documents that contain either of both of these words. Let a be the set of documents that contain A but not B, let b be the set that contain B but not A, let c be the set that contain A and B but not the phrase AB and let z be the set that contain the phrase AB. Let the number of documents within a, b, c and z be denoted by a, b, c and z also.
Then A is related to B if c+z>k(a+c+z), where k is a constant, 0<k<<1 and B is related to A, if c+z>k(b+c+z).

This formulation allows for the possibility that A and B are related one way, but not the other, e.g. if A predicts B but B does not predict A.

If A and B are related and z>k′(c+z), where k′ is a constant, 0<k′<<1, then the phrase AB is added to the list of identified phrases.

k and k′ are constants that may be chosen according to the number of documents in the collection, and how many phrases are sought. For indexing the World Wide Web (or any large collection of documents), reasonable values may be k=0.01 and k′=0.1, which means that A and B are related if one occurs in at least 1% of documents in which the other is present, and that the phrase AB is identified as a phrase if it occurs in at least 10% of documents in which both words are present. These values are not fixed but are the choice of the program designer, and do not have any objectively correct or optimum values but must be adjusted appropriately for the context.

It may be desirable to reduce the value of k if the words A and B are very common For example, suppose that A=“oxford” and B=“street”. These are both common words and it is possible that using a value of k=0.01 the System will fail to detect that they are related, which would mean that the System failed to identify “oxford street” as a phrase. By reducing the value of k for common words, the System will be better able to identify all valid phrases.

Next consider the extension of the above method to a three-word phrase consisting of the ordered list of words ABC. The Venn diagram in FIG. 4 shows the sets of documents that contain one, two or all of these words.

### Then,

A is related to B if d+g+z>k(a+d+f+g+z)
A is related to C if f+g+z>k(a+d+f+g+z)
B is related to A if d+g+z>k(b+d+e+g+z)
B is related to C if e+g+z>k(b+d+e+g+z)
C is related to A if f+g+z>k(c+e+f+g+z)
C is related to B if e+g+z>k(c+e+f+g+z)

The conditions for the phrase ABC to be identified are:
((A is related to B and to C) or (B is related to A and to C) or (C is related to A and to B)) and z>k′(g+z).

The above approach can be arbitrarily extended to phrases of any length.

In this manner it can be decided whether any potential phrase is to be identified by the Phrase Identification System. An efficient method for implementing this system follows.

A substantial efficiency gain can be made by assuming that all N-word phrases identified will contain an (N−1)-word phrase identified by the system. Then, for example, it is necessary for the system to consider only the 3-word phrases that contain 2-word sub-phrases that the system has previously identified. In reality, it is conceivable that this may miss some phrases, but these will be extremely rare, and can be considered a worthwhile compromise, given that the task of considering every possible phrase requires an unworkable amount of data calculation and storage.

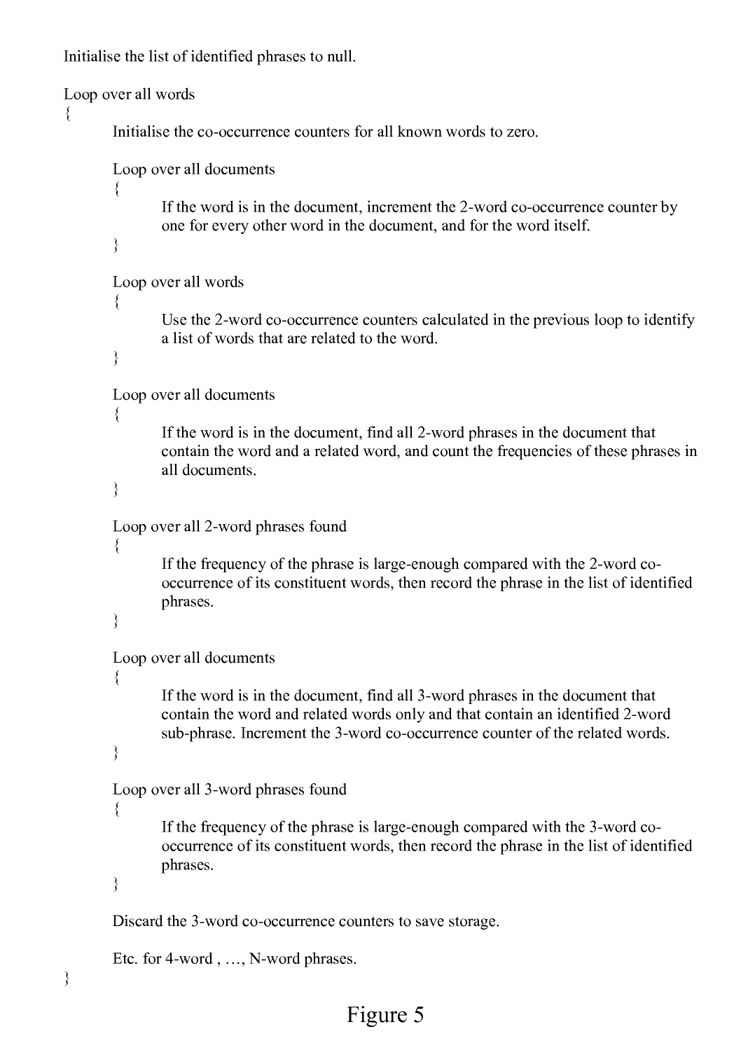

An efficient algorithm for identifying phrases in a document collection is shown in FIG. 5. The algorithm can identify phrases up to any desired number of words, N, or until a value of N is reached for which the number of phrases identified is zero, i.e. until all possible phrases have been identified. It is worth noting that this algorithm is capable of detecting phrases that contain multiple instances of a word, e.g. “knock knock joke”.

Having identified all phrases in the document collection, the next step for the Phrase Identification System is to remove any N-word phrase that appears mostly as a sub-phrase of an (N+1)-word phrase. For example, the phrase “romeo and” appears almost always as a sub-phrase of “romeo and juliet.” The System should therefore remove “romeo and” from the list of phrases because the phrase “romeo and juliet” has meaning, whereas “romeo and” is simply a sub-phrase and has little or no meaning in isolation.

Similarly, the System should remove any N-word phrase that appears almost always as a sub-phrase even if there are many (N+1)-word phrases that contain it as a sub-phrase. For example, the phrase “university of” is unlikely to appear on its own—it will almost always appear as a sub-phrase, for example, “university of oxford”, “university of cambridge”, etc. Therefore the System should remove it from the list of phrases, even though its frequency is actually greater than any of the phrases in which it appears.

However, the System should not remove phrases that very often appear as sub-phrases of other phrases, but are nevertheless valid phrases in their own right. Consider the phrase “sarah jane” as an example. At first glance this may appear to be similar to “university of”, in the sense that it very often appears as a sub-phrase in a 3-word phrase, e.g. “sarah jane monis”, etc. However, it is a valid phrase in its own right.

The key to differentiating between these two cases is to consider the number of documents in which phrases occur. An N-word phrase that appears as a sub-phrase in one or more (N+1)-word phrases is valid if:

$$\frac{{ND}_{N}}{\sum {ND}_{N + 1}} > {k}_{p}$$

Where ND_{N} is the number of documents in which the N-word phrase occurs, ND_{N+1} is the number of documents in which an (N+1)-word phrase occurs, the summation sign is a sum over all (N+1)-word phrases that contain the N-word sub-phrase, and kₚ is a parameter with a value chosen such that kₚ>1. An appropriate value of kₚ may be 1.1.

The System saves the list of phrases, ordered such that the phrases with the greatest number of words appear first. Among phrases of the same length, the most common phrases appear first.

### Document Processing System

Once the Document Indexing System has identified all words and phrases in the document collection, the Document Processing System converts the raw HTML content of each document into lists of tokens representing its constituent words and phrases. The processed documents are saved in the Document Index in this compact form. This makes further operations on the documents more efficient, because the System will not need to repeatedly search for lists of words constituting phrases within the text.

Words that are separated by mark-up tags that mark the start or end of headings, paragraphs or other semantic structures will not be considered to form phrases.

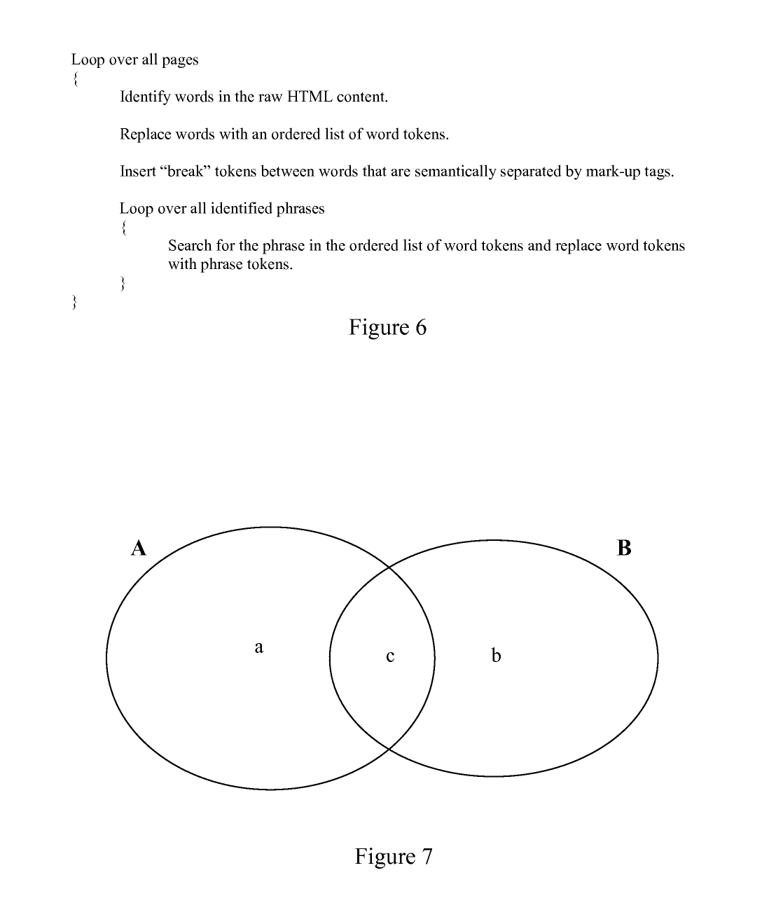

An algorithm for converting the raw HTML content into a list of word and phrase tokens is shown in FIG. 6. Because the System has saved the phrases ordered firstly by the number of words in the phrase and secondly by the frequency of finding the phrase in documents, this algorithm will find and replace phrases with many words in preference to phrases with fewer words, and will replace common phrases in preference to uncommon ones. For example, consider the sequence of words “earl” “grey” tea”. Suppose that both “earl grey” and “earl grey tea” have been identified as phrases. Then the greatest possible meaning will be derived by converting “earl” “grey” “tea” into “earl grey tea”, rather than “earl grey” “tea”. Next consider the sequence of words “large” “cucumber” “sandwich”. This should clearly be replaced by “large” “cucumber sandwich”, and not “large cucumber” “sandwich”.

A document may contain both a compound phrase and one or more constituent words or sub-phrases in addition. In this case the processed document will contain tokens for both the compound phrase (e.g. “president of the united states”) and the word or sub-phrase (e.g. “united states”).

### Related Phrase System

In a search for the most relevant document in a collection, the best match is the document that contains the most relevant and interesting information. I.e. a good document is one that does not simply contain the user's search query (or variations of it) echoed back, but that contains the answer to the user's implied question. For example, if the search is for “university”, then an ideal document may be one that explains what a university is, how it functions, and lists examples of well known and prestigious universities. Such a document would almost certainly contain words such as “science”, “school”, “department”, “research”, “professor”, etc. that are related to the search query. In fact, the more such words, the more likely the document is to be relevant to the search. The Related Phrase System needs to identify related words and phrases so that they can be used to score documents.

The Related Phrase System uses the approach previously used to identify related words, except that now it is used to identify related words and phrases. As previously discussed, this method offers advantages over known “information gain” approaches. Having identified related words and phrases, the next step is to use this information to calculate document relevance.

The method of calculating document relevance can also be used to calculate the relevance of links pointing to the document from other documents, and this in turn can be used to calculate the authority of the document. The method can also be used to score a document based on its domain type or extension.

First it is necessary to identify related words and phrases. A matrix is constructed having, on both axes, every identified word and phrase, and a relatedness score is determined at each entry. An information gain approach could be used to identify words and phrases that are related to one another; however in the present embodiment the Related Phrase System extends the approach previously described in the Phrase Identification System, to identify not just related words but related words and phrases. As previously discussed, this method offers advantages over the information gain approach.

Having identified related words and phrases, the next step is to use this information to calculate document relevance.

The derivation of a formula for the relevance of a document according to this embodiment of the invention can be motivated and explained through the language of probability theory as follows.

Assume that a hypothetical “best matched” document exists; i.e. the one document that the human user conducting the search would judge to be the most appropriate response to the specified search query. This hypothetical construct of a “best matched” document is necessarily artificial, since it may not always be possible for a human user to determine uniquely a most-appropriate document, but it is nonetheless a helpful aid for motivating the derivation of the formula, and checking that its behaviour accords with an intuitive human understanding of judging relevance.

Consider the case of two related words or phrases, A and B, where A is the search query. It is possible that the “best matched” document lies in any of the three areas in the Venn diagram in FIG. 7. The region a represents the collection of documents from the whole corpus that contain the word A but not B, the region b represents the collection of documents that contain the word B but not A, and the region c represents the collection of documents that contain both A and B.

For simplicity of notation, let a, b and c denote both the collections themselves and the number of documents in each collection, depending on context. Let P(a), P(b) and P(c) denote the probabilities that the “best matched” document lies within a, b and c respectively. There is, of course, no formula for these probabilities since it depends on subjective human assessment; however the following discussion aims at arriving at formulae for modelling these probabilities. The relevance, Rₐ, of a document that lies within a to the search query A is defined to be the probability that a document selected at random from the collection a is the “best matched” document; i.e. P(a)=aRₐ. Similarly, P(b)=bR_{b} and P(c)=cR_{c}.

The underlying assumption in the following analysis is that the relevance of a document to the search query A depends on which words and phrases it contains and how those words and phrases relate to each other. For example, the more closely that the set of documents containing A overlaps with the set of documents containing B, the higher the co-occurrence of words of phrases A and B across the whole corpus, and therefore the more probable it is that the best matched document itself would contain both A and B; i.e. lie in collection c. Therefore R_{c} should increase the greater the overlap. This is because the word or phrase B is then indicated as more strongly relating to the word or phrase A, and therefore a document that contains both words or phrases is more likely to contain relevant content about A than a document that contains A but not B.

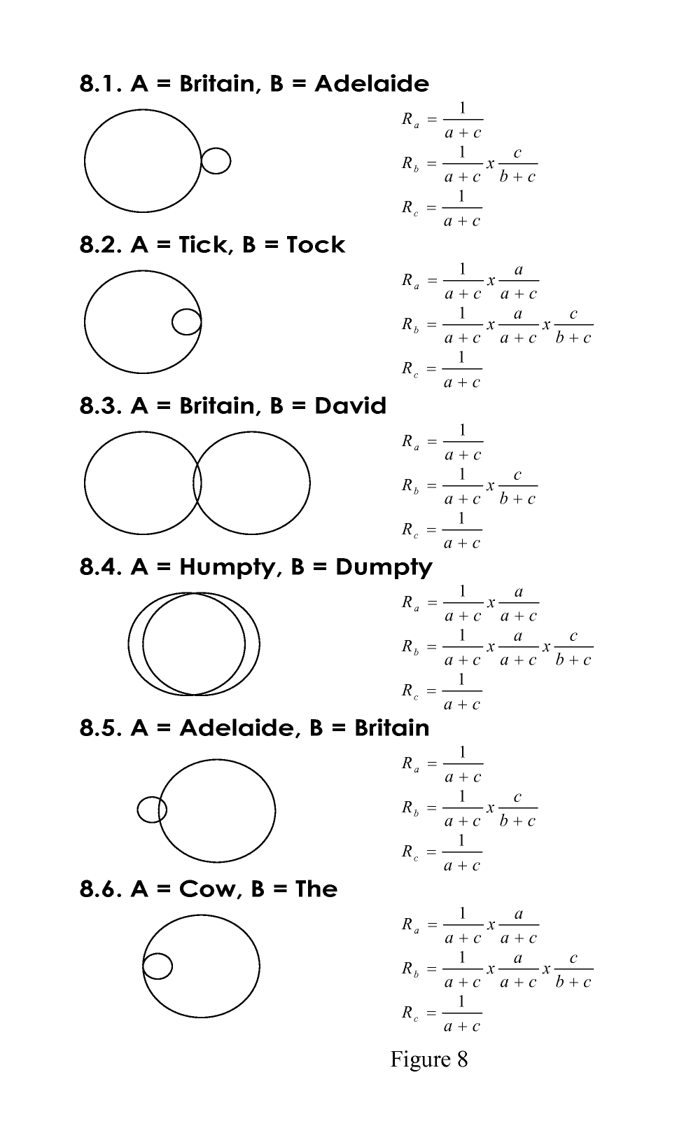

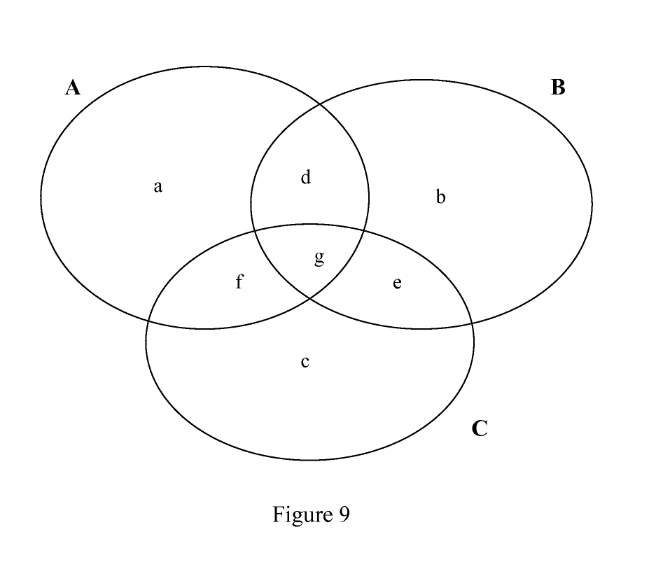

Appropriate formulae to model Rₐ, R_{b} and R_{c} can be deduced by considering the six scenarios shown in FIG. 8 and determining formulae that behave “well” in each scenario.

In scenario 8.1 a and c are equally relevant; and R_{b}≅0 but becomes larger the more that the words A and B overlap. In scenario 8.2 as c becomes larger, the relevance of a is reduced; and the relevance of b increases the more that A and B overlap. Scenario 8.3 leads to the same equations as scenario 8.1: the size of B relative to A is unimportant. In scenario 8.4 the relevance of a is diminished; by symmetry, the relevance of b is approximately equal to a; and P(c)≅1. Scenario 8.5 leads to the same equations as scenario 8.1: the size of B is unimportant.

In scenario 8.6 the relevance of a is diminished; and P(b)≅0 with P(c)≅1. A search for “Cow” is an implied search for “Cow” and “The”. Even though A is entirely within B, the word B on its own has little relevance. In this scenario, it is apparent that documents that do not contain the word “the” (effectively web pages that do not contain English language text) will be assigned very low relevances.

From a consideration of these limiting cases it seems reasonable to define:

$${R}_{a} = \frac{1}{a + c} \times \frac{a}{a + c}$$

$${R}_{b} = \frac{1}{a + c} \times \frac{a}{a + c} \times \frac{c}{b + c}$$

The term

$$\frac{1}{a + c}$$

is the relevance of all documents containing A in a simple Boolean model (i.e. where the presence or absence of the search words determines the returned document). The term

$$\frac{a}{a + c}$$

represents the reduction in probability that a document containing A alone is relevant when A and B overlap. The term

$$\frac{c}{b + c}$$

represents the increase in probability that a document containing B is relevant when A and B overlap.

The scenarios suggest a formula for R _{c} too, however it must be true that P(a)+P(b)+P(c)=1, so R_{c} can be calculated as follows:

$$\begin{matrix}P ( c ) = 1 - \frac{{a}^{2}}{{( a + c )}^{2}} - \frac{abc}{{( a + c )}^{2} ( b + c )} \\ = \frac{{( a + c )}^{2} ( b + c ) - {a}^{2} ( b + c ) - abc}{{( a + c )}^{2} ( b + c )}\end{matrix}$$

$$P ( c ) = c \frac{( a + c ) ( b + c ) + ac}{{( a + c )}^{2} ( b + c )}$$

$${R}_{c} = \frac{1}{a + c} + \frac{ac}{{( a + c )}^{2} ( b + c )}$$

An additional term has been added to R_{c}, which can be expressed as

$$\frac{1}{a + c} \times \frac{a}{a + c} \times \frac{c}{b + c} = {R}_{b}$$

### Hence,

$${R}_{a} = \frac{1}{a + c} \times \frac{a}{a + c}$$

$${R}_{b} = \frac{1}{a + c} \times \frac{a}{a + c} \times \frac{c}{b + c}$$

$${R}_{c} = \frac{1}{a + c} + {R}_{b}$$

It is clear that R_{c}>R_{b}, R_{c}>Rₐ and Rₐ>R_{b}.

It has already be shown that P(a)+P(b)+P(c)=1. It is clear from the expressions for Rₐ and R_{b} that 0≦Rₐ≦1 and 0≦R_{b}≦1. It follows that 0≦R_{c}≦1.

As in the Phrase Identification System, A is considered to be related to B if

$$\frac{c}{a + c} > k$$

where k is a constant such that 0<k<<1. For practical purposes one might choose k=0.01.

In the above discussion, it is implicitly assumed that A is related to B and to no other words or phrases. In order to extend the 2-word analysis to the general case where many words and phrases are related to each other, it will be useful to introduce some new notation.

The expressions for the relevances derived in the previous section, are probabilities and are therefore normalised such that 0≦Rₐ≦1,0≦R_{b}≦1 and 0≦R_{c}≦1. However both insight and economy in notation can be obtained by renormalizing these expressions and writing them as follows:

Rₐ=1

R_{b}=β

R_{c}=1+α+β

### Where

$$α = \frac{c}{a} and β = \frac{c}{b + c} .$$

In this renormalized notation, the values of relevance still have a minimum value of zero, but their maximum is now unlimited.

There is a potential problem here because the formula for α is undefined if a=0. But this could happen only if a particular word or phrase always appears with another word or phrase, never on its own. For the vast majority of cases, α<<1. In the very rare event that a=0 the difficulty can be avoided by setting a=1 in this case. This will be a very close approximation and will not materially affect the results. In effect this supposes that a single imaginary document exists that contains A but not B.

An alternative approximation would be to write

$$α = \frac{c}{a + c}$$

which would make α defined for all values of a.

By considering the renormalized relevances, it becomes clearer how sensibly to extend the expressions to an arbitrary number of words and phrases. However first consider the case of three related words or phrases, A, B and C, where A is the search query. Then it is possible that the document that best matches the search could be drawn from any of the three areas in the Venn diagram show in FIG. 9.

By analogy with the case of two keywords, and by computing Σᵢ₌₁ⁿP(aᵢ)=1 for various limiting cases, it can be shown that:

$${R}_{a} = \frac{1}{a + d + f + g} \times \frac{a}{a + d + f + g}$$

$${R}_{b} = \frac{1}{a + d + f + g} \times \frac{a + f}{a + d + f + g} \times \frac{d}{b + d + e + g}$$

$${R}_{c} = \frac{1}{a + d + f + g} \times \frac{a + f}{a + d + f + g} \times \frac{f}{c + e + f + g}$$

$${R}_{d} = {R}_{b} + \frac{a + d}{{( a + d + f + g )}^{2}}$$

$${R}_{e} = {R}_{b} + {R}_{c} + \frac{1}{a + d + f + g} \times \frac{a}{a + d + f + g} \times \frac{g}{e + g}$$

$${R}_{f} = {R}_{c} + \frac{f}{{( a + d + f + g )}^{2}}$$

$${R}_{g} = \frac{1}{a + d + f + g} + \frac{d + f}{{( a + d + f + g )}^{2}} + {R}_{e}$$

By analogy with the 2-word case, define

$${α}_{1} = \frac{d}{a} , {α}_{2} = \frac{f}{a} , {β}_{1} = \frac{d}{b + d + e + g} and {β}_{2} = \frac{f}{c + e + f + g} .$$

α₁ can be interpreted as the number of documents that contain only A and B divided by the number of documents that contain only A. β₁ can be interpreted as the number of documents that contain only A and B divided by the number of documents that contain B . This observation will help to formulate the general N-word case later.

As discussed above, it is expected that all four of these parameters will normally be much less than one. Hence, terms that are non-linear in αᵢ and βᵢ can normally be ignored. Then, renormalizing and using this linear approximation,

Rₐ=1

R_{b}=β₁

R_{c}=β₂

R_{d}=1+α₁+β₁

Rₑ=β₁+β₂

R_{f}=1+α₂+β₂

R_{g}=1+α₁+β₁+α₂+β₂

This linear approximation clearly provides a great degree of simplicity of notation, and also makes the computation of the probabilities much less numerically intensive. It also gives some insight into the relevance of the possible document types. The relevance contains a term (1) for documents that contain A. Documents that contain another related word or phrase also add αᵢ and βᵢ terms. Documents that do not contain A have a relevance of order βᵢ.

The approximation is valid provided that the neglected terms, which are non-linear in α₁ and βᵢ, are small. In the rare cases where this is not true, the approximate formulae will underestimate the relevance of any document that contains many words or phrases that overlap each other substantially in the Venn diagram. This would be particularly true when the regions B and C overlap extensively. These are words or phrases that can be considered to be very similar. For example, in a search for “university” the words “physics” and “chemistry” may tend to cluster together. The linear approximation would tend to underestimate the relevance of a document that contained these closely related words. It would be a worse approximation to over-estimate the relevance of a document that contained many similar words or phrases, as this would make the method susceptible to abuse by webmasters.

Consider the case where the search query is A, and there are N related words or phrases, Bᵢi=1, . . . , N. By consideration of the 2- and 3-word cases, a general formula for the relevance R of a document suitable for any number of words is given as follows:

R=0, if the document does not contain A, or any Bᵢ,i=1, . . . , N;

R=1, if the document contains A, but none of Bᵢ,i=1, . . . , N;

R=Σβᵢ, if the document contains one or more Bᵢ,i=1, . . . , N but not A;

R=1+Σαᵢ+Σβᵢ, if the document contains A and one or more Bᵢ,i=1, . . . , N;

where the summation sign Σ means the sum of whichever values of Bᵢ are present in the document. αᵢ is defined to be the number of documents that contain A and Bᵢ divided by the number of documents that contain A but not Bᵢ. βᵢ is defined as the number of documents that contain A and Bᵢ divided by the total number of documents that contain Bᵢ.

This general formula reduces to the 2-word case exactly, and reduces to the 3-word linear approximation. It enables the relevance of any document or document component to be calculated for any search query.

Alternatively the approximation could be used that αᵢ is the number of documents that contain A and Bᵢ divided by the number of documents that contain A (including those that contain both A and Bᵢ). This has the advantage that the relatedness function that relates words and phrases has the same functional form as the relatedness function that relates words in the Phrase Identification System. It also has the advantage of being well-defined for all possible numbers of documents in A and Bᵢ.

In one embodiment of the current invention, only words for which αᵢ>k and βᵢ>k are retained. By discarding related words that do not meet these criteria, the number of words related to very common words such as “the” will be greatly reduced.

In one embodiment of the current invention, the frequency and co-occurrence counts used to calculate the αᵢ and βᵢ values are weighted by the page popularity. This will help to reduce the influence on the probability relationships of low quality documents.

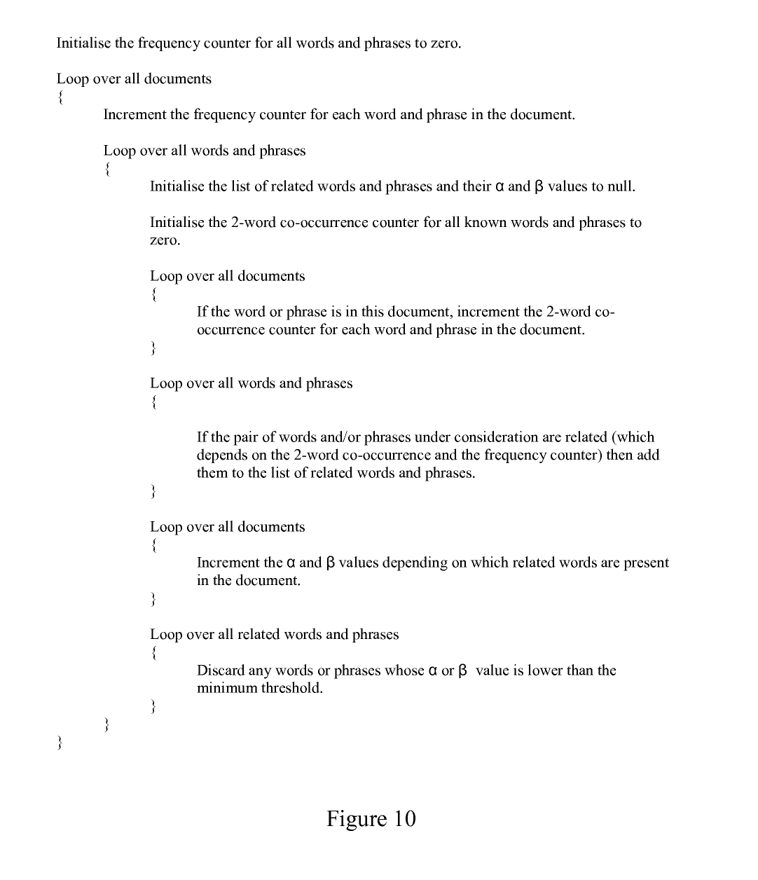

From the above discussion it is now clear what information the Related Phrase System needs to calculate and store. For every word and phrase identified, the System will calculate and store a list of related words and phrases, and the α and β values associated with each. An efficient algorithm for doing this is shown in FIG. 10.

### Document Relevance System

Having identified and stored all words and phrases, and calculated and stored the related words and phrases and their α and β values, the Document Relevance System can now calculate the relevance of any document to any search word or phrase.

This could potentially be done in real time by the Search System. However, it is far more efficient to calculate the relevances in advance, so that they are already available when the Search System requires them. This will make the Search System very fast indeed, because the search results for every possible search word or phrase will already be known and just need to be looked up. This is simply impossible for traditional search engines, as the search engine has no way of knowing in advance what the user will search for, and the results for any given search query must be calculated each time a search is made. By contrast, the current invention already “knows the answer” to every possible search word or phrase, because of its identification of words and phrases. This makes the Search System much faster than traditional information retrieval systems.

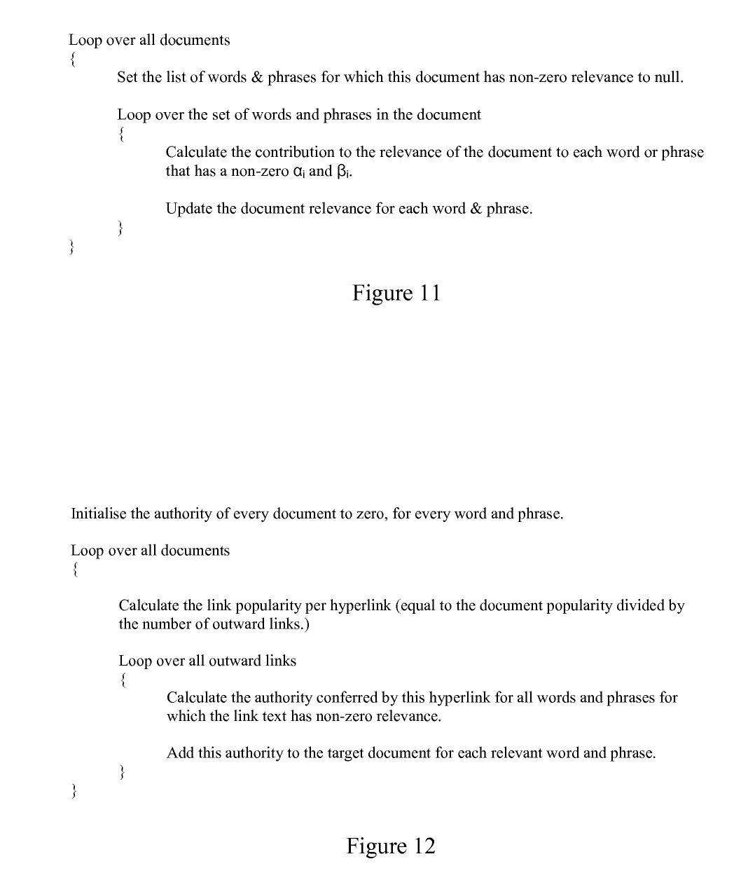

The calculation of every possible search result would be a very time-consuming task and would require a vast amount of storage. Fortunately, it isn't necessary to calculate and store every possible result for every search word and phrase, and for every document. This is because most documents will have zero relevance for most searches. This means that the System needs to calculate and store only a small fraction of the total possible document relevances. An efficient algorithm for doing this is shown in FIG. 11.

This algorithm can be applied to any component of a document—not just the body text. In the current invention the System calculates the relevance of the following document components: the body text, the document title, the domain name and the URL. Each of these can be considered to be an indicator of overall document relevance: the body text is usually the main content of the document; the title is often highly indicative of the content of the document; a domain name that contains a relevant word or phrase should be considered both relevant and authoritative; and a URL that contains a relevant word or phrase should also be considered relevant.

### Document Relevance System: Body Text

In one embodiment of the current invention, the document title is included with the document body text when calculating the relevance of the body text. This is because the document title can be considered to be part of the visible document content.

In one embodiment of the current invention, the System treats text that appears in back-links (links that refer to the document) as if it appeared in the document body text itself.

Such text is clearly “about” the document and is therefore a description of its content. For example, the google.com home page may not contain the phrase “search engine”, but the page is an excellent match to the search query “search engine”. Treating text in back-links as if it appeared in the document body text is also a way of recognising synonyms and misspellings. For example, if a word is commonly misspelt, then misspellings of the word may appear in links to the document, although the document itself contains the correct spelling.

The value of the body text relevance will lie between 0 and

$${R}_{max} = 1 + {\sum }_{i = 1}^{N} {α}_{i} + {\sum }_{i = 1}^{N} {β}_{i} .$$

The System will divide the relevance by Rₘₐₓ to obtain a normalised body relevance that lies between 0 and 1.

### Document Relevance System: Document Title

In one embodiment of the current invention, the title relevance is calculated using only the visible part of the document title. This will prevent webmasters “cheating” by creating very long document titles incorporating all possible related words and phrases. The 2 0 System may calculate the title relevance using a restricted number of words, e.g. the first 10 words only.

In one embodiment of the current invention, the System selects only a single word or phrase to use when calculating the relevance of the document title. The word or phrase selected will be the one that contains the greatest number of words and has the highest frequency, as this can be considered to be the phrase that best represents the meaning of the title. This is the same algorithm as the one used by the Document Processing System to replace raw text with phrase tokens. For example, when calculating the relevance of a document for the word “oxford”, if the title is “science at oxford university”, the system may select “oxford university” as the phrase that best represents the subject of the title. This would have less relevance than a title containing just the word “oxford”—not because the title is longer, but because it is not strictly about “oxford” but is about the related phrase “oxford university”.

In a further modification, the system may allow multiple related words and phrases in the title to count towards relevance. If the title contained an exact match to the search word or phrase, then its relevance would be 1. If the title did not contain the search word or phrase but did contain related words or phrases, then its relevance would be

$${\sum }_{i} {β}_{i} .$$

For example, if the search query were “oxford”, and the document title were “science at oxford university”, then the relevance would be the sum of β values of “science” and “oxford university”. The justification for including multiple related words and phrases is that their presence indicates multiple ways in which the title is relevant. The reason for excluding related words and phrases if the search word or phrase is itself present in the title is that doing so negates the effects of unnatural language and “cheating” by webmasters.

In one embodiment of the current invention, the System selects only a single word or phrase to use when calculating the relevance of the document title. The word or phrase selected will be the one that contains the greatest number of words and has the lowest frequency. For example, when calculating the relevance of a document for the word “oxford”, if the title is “oxford—home of a university”, then the System would select the word “university” and calculate the relevance of the title based on that. The justification for this is that the title indicates that the document is not strictly about “oxford”, but is about a more specific related subject—its “university”.

The value of the title relevance will lie between 0 and Rₘₐₓ, where the value of Rₘₐₓ depends on which of the above embodiments is used. The System will divide the relevance by Rₘₐₓ to obtain a normalised title relevance that lies between 0 and 1.

### Document Relevance System: Domain Name

The System calculates the relevance of a domain name as the relevance of any single word or phrase contained within it. For this purpose, the domain “name” excludes any domain extension such as “.com” and excludes any sub-domains. The domain is treated in this special way because it carries both relevance and “authority” as it is difficult to “fake”.

The System selects only a single word or phrase to use when calculating the relevance of the domain. The word or phrase selected will be the one that contains the greatest number of words and has the highest frequency, as this can be considered to be the phrase that best represents the meaning of the domain. This is the same algorithm as the one used by the Document Processing System to replace raw text with phrase tokens.

In a domain name, a phrase will be detected only if its constituent words appear without any additional words or characters separating them, or are separated by a hyphen.

In one embodiment of the current invention, domains containing extra words or characters in addition to the detected word or phrase are reduced in relevance. This is because such domains are less focussed than a domain containing only the detected word or phrase. If the total number of characters in a domain name is NCₜₒₜₐₗ and the number of characters in the detected word or phrase is NC_{word}, then the domain relevance is reduced by a factor of NC_{word}/NCₜₒₜₐₗ.

The value of the domain relevance will lie between 0 and Rₘₐₓ, where the value of Rₘₐₓ depends on which of the above embodiments is used. The System will divide the relevance by Rₘₐₓ to obtain a normalised domain relevance that lies between 0 and 1.

### Document Relevance System: URL

The System calculates the relevance of a document URL as the relevance of any single word or phrase contained within it. The URL consists of the entire document URL including the domain name. A relevant domain name can therefore contribute to both the domain relevance and the URL relevance.

The System selects only a single word or phrase to use when calculating the relevance of the URL. The word or phrase selected will be the one that contains the greatest number of words and has the highest frequency, as this can be considered to be the phrase that best represents the meaning of the URL. This is the same algorithm as the one used by the Document Processing System to replace raw text with phrase tokens.

In a URL, a phrase will be detected if its constituent words appear in the correct order, regardless of whether they are separated by any additional words or characters. The System does not take into account the total number of characters in the URL, since URL's are often required to contain additional words or characters for technical or architectural reasons.

The value of the URL relevance will lie between 0 and 1, and is therefore already normalised.

### Document Relevance System: Overall Relevance

The relevance of the document's body text, title, domain and URL are denoted by R_{body}, Rₜᵢₜₗₑ, R_{domain} and Rᵤᵣₗ.

The question now arises of how to combine these four values to obtain an overall value for the document relevance, R.

Since the relevances are probabilities, probability theory can be used to obtain lower and upper bounds for R. If R_{body}, Rₜᵢₜₗₑ, R_{domain} and Rᵤᵣₗ were independent, then:

R=R_{body}RₜᵢₜₗₑR_{domain}Rᵤᵣₗ

On the other hand, if R_{body}, Rₜᵢₜₗₑ, R_{domain} and Rᵤᵣₗ were mutually exclusive, then:

R=R_{body}+Rₜᵢₜₗₑ+R_{domain}+Rᵤᵣₗ

In reality, the true value will lie between these two bounds, since Rₜᵢₜₗₑ, R_{domain}, Rᵤᵣₗ and R_{body} are not independent (in fact, they are likely to be closely related) and are certainly not mutually exclusive.

A practical solution to combining the relevances is now proposed. First note that there is a “hierarchy” of importance. Whilst in an ideal world one would prefer to find a document whose domain, URL and title contained either the search query or a closely related word or phrase, there would be little value in finding such a document if it contained no relevant body text. A document that contained rich relevant body text, even if its domain, URL and/or title offered no hint of relevance would be preferable. Therefore R_{body} must be given greater weight than the other values.

Based on this insight, and using the upper and lower bounds previously derived, the following formula is proposed as a practical way to combine the relevances:

R=R_{body}+R′ₜᵢₜₗₑ+R′_{domain}+R′ᵤᵣₗ

Where R′ₜᵢₜₗₑ=Rₜᵢₜₗₑ, Rₜᵢₜₗₑ<R_{body}

R′ₜᵢₜₗₑ=R_{body}, Rₜᵢₜₗₑ≧R_{body}

In words, R′ₜᵢₜₗₑ is a truncated relevance, such that it is not permitted to be larger than R_{body}. Similarly,

R′_{domain}=R_{domain}, R_{domain}<R_{body}

R′_{domain}=R_{body}, R_{domain}≧R_{body}

R′_{URL}=R_{URL}, R_{URL}<R_{body}

R′_{URL}=R_{body}, R_{URL}≧R_{body}

The System saves the overall relevance R for every document, and for every word and phrases for which it is non-zero.

### Document Relevance System: Domain Extension

The type of domain is another indicator of relevance. The method can assess whether documents that contain a particular word are more likely to appear on any particular domain extension, and use this to help determine relevance. For example, in a search for “president of the united states” it may be that a .gov domain will be preferred to a .com.

The probability that a document containing a search query A has a domain extension of type dom is equal to the total number of documents containing A and of domain extension dom divided by the total number of documents containing A.

$${P}_{dom \vert A} = \frac{{N}_{dom \vert A}}{{N}_{A}}$$

The probability that a random document drawn from the collection has a domain extension of type dom is equal to the total number of documents of domain extension dom divided by the total number of documents.

$${P}_{dom} = \frac{{N}_{dom}}{N}$$

A weighting factor that accounts for the tendency of documents containing the search query A to be of domain type dom is equal to P_{dom\A}/P_{dom}. In one embodiment of the current invention, the overall document relevance is multiplied by this weighting factor.

In one embodiment of the current invention, the weighting factor is calculated using the average page popularity scores in place of the number of documents in the formulae for P_{dom\A} and P_{dom}.

### Document Authority System

Having calculated the total relevance of each document to every identified word and phrase, the next step is to calculate authority. As previously discussed, authority is subject-specific. The System calculates the authority of each document for every word and phrase identified.

In a Boolean model of relevance, the authority conferred by a single hypertext link on a target document is zero if the link text does not include the word or phrase. If the link text does include the word or phrase then the authority conferred is equal to the popularity of the source document divided by the number of outward links in the document. The total authority of a document is calculated as the sum of the authority conferred by all links that target the document.

In the present invention, a generalisation of the Boolean model is used. The authority conferred by a single hyperlink is the product of the relevance of the link text, the relevance of the source document, and the popularity of the source document divided by the number of outward links in the document. The authority of a document is the sum of the authority conferred by all links that target the document.

This means that a link may confer authority even if it does not contain an exact match to the word or phrase, but does contain related words or phrases. The relevance of the link text is calculated in the same way as document relevance.

Some ways in which the calculation of relevance may be modified in different embodiments of the invention are now proposed.

In order to prevent “cheating” by webmasters creating unnaturally long link text containing many related words and phrases, the System may select a single word or phrase to use when calculating the relevance of the link text. The word or phrase selected will be the one that contains the greatest number of words and has the highest frequency, as this can be considered to be the phrase that best represents the meaning of the link text. This is the same algorithm as the one used by the Document Processing System to replace raw text with phrase tokens. For example, when calculating the authority of a document for the word “oxford”, if the link text is “science at oxford university”, the system may select “oxford university” as the phrase that best represents the subject of the link. This would confer less authority than a link containing just the word “oxford”—not because the link text is longer, but because it is not strictly about “oxford” but is about the related phrase “oxford university”.

In a further modification, the system may allow multiple related words and phrases to count towards relevance. If the link text contained an exact match to the search word or phrase, then its relevance would be 1. If the link text did not contain the search word or phrase but did contain related words or phrases, then its relevance would be

$${\sum }_{i} {β}_{i} .$$

For example, if the search query were “oxford”, and the link text were “science at oxford university”, then the relevance would be the sum of β values of “science” and “oxford university”. The justification for including multiple related words and phrases is that their presence indicates multiple ways in which the link text is relevant. The reason for excluding related words and phrases if the search word or phrase is itself present in the link text is that doing so negates the effects of unnatural language and “cheating” by webmasters.

An efficient algorithm for calculating authority is shown in FIG. 12.

### Thematic Content Score System

The System calculates the thematic content score of every document. The thematic content score of a document is defined as the sum of its relevances for all words and phrases. A document with a high thematic content score is likely to contain a substantial body of content themed around some well-defined topic, so that the words and phrases that it contains support each other in contributing to its overall thematic content score.

A domain with a high average thematic content score would generally contain documents that are themed and with plenty of on-topic content. Conversely, a domain containing documents with little content or with poorly organised content would tend to have a low thematic content score. Thematic content score can therefore be regarded as a subject-independent measure of the “worth” of a domain.

In one embodiment of the current invention, the document score, which is equal to the product of its relevance and its authority, is multiplied by the average thematic content score of its domain to create a modified score. This would tend to downgrade documents on domains with generally poor content.

### Search System

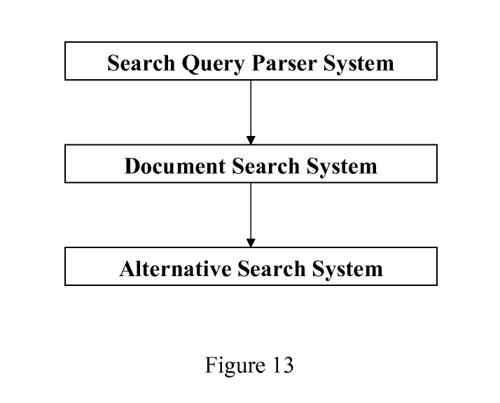

FIG. 13 shows the main components of the Search System which are described in more detail below. In brief, these are a Search Query Parser System that reads a user's search query and splits it into its constituent words and phrases; a Document Search System that finds the pages that have the greatest value of relevance multiplied by authority multiplied by thematic content score for each constituent word or phrase in the search query, and finds the pages that best match the complete search query; and an Alternative Search System that suggests alternative searches based on the frequency of identified words and phrases.

### Search Query Parser System

The Search Query Parser System reads the user's search query that has been passed from the Front End Server. The query is first converted to lower case. It is then parsed for known words and phrases.

A word is any sequence of printable characters that is separated from other words by a character such as a space, comma, question mark, etc. The Search Query Parser System breaks the search query into its constituent words and replaces these words with word tokens corresponding to words that were identified by the Word Identification System. If the System detects that the user has entered a word that does not appear anywhere in the document collection, the Front End Server will display a message informing the user that no search results are possible for this search query.

To detect phrases, the Search Query Parser System uses the same algorithm used by the Document Processing System. The System loops over all identified phrases, searching for the phrase in the ordered list of word tokens, and replacing word tokens with phrase tokens when found.

This results in a search query comprising one or more identified words or phrases, stored as word or phrase tokens.

### Document Search System

In the case of a search query comprising a single word or phrase, the Document Search System obtains the score for each document from the Document Index, and the documents are sorted by score.

In the case of a compound search query comprising more than one word or phrase, the System calculates the overall score of a document as the product of document scores for the component search queries. In probabilistic terms, the component search terms are considered to be independent, so that the overall score of a document would be the product of its component scores.

For example, if the search query were “buckingham palace opening times” the Search System may interpret this as “buckingham palace” +“opening times” and would find documents that contained information relevant to both “buckingham palace” and “opening times”.

This approach should also enable the System to handle natural language search queries, e.g. “where is ottawa?” The phrase “where is” ought to be correlated with relevant geographical and directional terms that will result in the selection of documents that contain information about the location of Ottawa.

### Alternative Search System

The Alternative Search System makes suggestions for alternative search queries based on the words and phrases identified and their frequencies. For example, if the user enters the search query, “kung”, the System may suggest, Did you mean “kung fu”?

The System will search for all identified phrases that begin with the search word or phrase. If any of the identified phrases begin with the search query and are more common than the search query itself, then the system will suggest them as alternative searches.

If the search query consists of more than one word, then the System will search for all identified phrases that begin with the search words. If any of the identified phrases begin with the search query, then the system will suggest them as alternative searches. For example, if the user enters the search query, “university of”, the System may suggest, Did you mean “university of oxford” or “university of cambridge”?

In one embodiment of the invention, the System will suggest the most common phrase only.

### Presentation System

The Presentation System finds text fragments, images and media objects that contain relevant content, and uses these as a description of each document. It may find only the most relevant text fragments and media objects in the best matched pages. It can display the results as an ordered list of page titles and/or text fragments and/or media objects.

A text fragment is defined to be a textual component from the document body text that begins and ends with a mark-up tag indicating the beginning or end of a semantic element, or that ends in a full stop. The mark-up language that marks the beginning or end of the text fragment is not part of the fragment, but any mark-up language that does not semantically break the fragment may be included. The text fragment may be a generalised text object that contains formatting elements, hyperlinks, etc.

An image object comprises the entire mark-up language needed to display the image on a web page. Any type of media object that contains a textual description can be treated in a similar way, e.g. video and audio files.

The following are examples of text and image objects. In these examples, the HTML mark-up language in italics is not part of the objects:
<h1>An introduction to particle physics</h1>
<p>Heisenberg's <a href=uncertainty-principle.html>uncertainty principle</a> states that it is impossible to know both the exact position and the exact velocity of an object at the same time.</p>
Einstein's <b>general theory of relativity</b> proposes that accelerated motion and gravity are <i>equivalent</i>.
<img src=“quantumgeometry.jpg” alt=“Quantum geometry: how string theory modifies Riemannian geometry”>

The relevance of a text fragment to the search query can be calculated using the same algorithm used by the Document Relevance System to calculate the relevance of document body text. An image or media object may include a textual description of the object which can be used to calculate its relevance. In the case of compound queries, a given object may not be relevant to all components of the compound query. For this reason, the overall score of a text or media object is calculated as the sum of relevances for each component word or phrase in the search query.

By calculating the relevance of text fragments, images and media objects, the Presentation System can select rich content to display for each document in the search results. The objects displayed will be highly relevant to the user, containing not just the search query and surrounding text, but supporting text that will help to “answer the user's question.” The objects will be semantically meaningful and may contain formatting, hyperlinks and media objects in addition to plain text.

It is not necessary for the System to display an equal amount of text or an equal number of text or media objects for every document in the search results. In one embodiment of the current invention, the System selects just those objects whose score exceeds the average score of the objects under consideration. In one embodiment, it selects the N highest-scoring objects.

The Presentation System can also be used to create a query-independent description of a document, using the document subject as if it were a search query (see Determining document subject, below).

### Extension to Image and Media Searches

The current invention can also be used to search for images, video and other forms of rich media on the World Wide Web. The multimedia object itself cannot be interpreted by the information retrieval system, unless it is equipped with some form of visual (or audio, etc.) perception. However, images and other rich media are usually accompanied by some kind of text that describes them. They are also hyperlinked from some kind of document or documents, or embedded within a document or documents. Sometimes the description and the hyperlink text are the same entity.

This supporting text can be used to perform multimedia searches, in a way that is exactly analogous to text searches. For instance, the text that describes an image is analogous to the body text in a document, and can be used to calculate the relevance of the image. The text that links the image to the document (or documents) in which it is embedded (or linked from) can be used to calculate the authority of the image.

In one embodiment of the current invention, the domain relevance and URL relevance of a media object are calculated and are combined with the relevance of its description to calculate an overall score. This is done in the same way as document relevances are combined by the Document Relevance System. In one embodiment of the current invention, the total score of an image or video object is multiplied by its size, in pixels. In one embodiment of the current invention, the total score of a video or audio file is multiplied by its duration, in seconds.

### Determining Document Subject

In addition to information retrieval, the invention can be used to determine the subject of a document. The Document Indexing System determines a score for every document for every identified word and phrase. This score is equal to the product of the document's relevance and authority for the word or phrase. The word or phrase with the highest score can be interpreted as the document's primary subject.

The Document Indexing System can determine a document's subject at the time of indexing it, and this information can be saved or passed to an external system for some other use, for example to display contextual advertising in the document according to its key subject. It may also be used by the Presentation System to inform the user what each document is “about.”

The System can be used to determine the subject of any document, even if it does not form part of the original document collection, e.g. e-mails, SMS messages, etc.

The System can also determine secondary subjects, and words or phrases that are related to the primary or secondary subjects. This would be useful if no adverts were available for the primary subject. In this case, the System could use a secondary subject or related words or phrases to source relevant advertising.

1. A computer-implemented method of determining the relevance, to a given word or phrase, of a document from a source collection of documents, the method comprising:
accessing a predetermined set of words and/or phrases that are related to the given word or phrase; and
calculating a document relevance score as a function of:
whether the word or phrase occurs in the document; and
for each word and phrase from the predetermined set, whether the related word or phrase occurs in the document.

2. The method of claim 1 comprising storing the calculated relevance score in a data store.

3. The method of claim 1 comprising transmitting the calculated relevance score to a search component for use in determining the results of a search query.

4. The method of claim 1 wherein said source collection of documents comprises a collection of documents publicly available on the World Wide Web.

5. The method of claim 1 wherein said collection of documents comprises multimedia content.

6. The method of claim 1 wherein the predetermined set of words and/or phrases that are related to the given word or phrase is a database of words and/or phrases stored on a data retrieval apparatus.

7. The method of claim 6 wherein the set of words and/or phrases that are related to the given word or phrase is constructed by analysing a relatedness-analysis collection of documents.

8. The method of claim 7 wherein said source collection of documents is the same as said relatedness-analysis collection of documents.

9. The method of claim 7 wherein said analysis is such that a first word or phrase appearing in the relatedness-analysis collection of documents is determined as being related to a second word or phrase using a relatedness function that indicates how related the first word or phrase is to the second word or phrase, the relatedness function including at least two terms selected from the group consisting of: the number of documents in the relatedness-analysis collection that contain both the first and second words or phrases; the number of documents that contain at least one of the first or second words or phrases; the number of documents that contain the first word or phrase; the number of documents that contain the second word or phrase; the number of documents that contain the first word or phrase but not the second word or phrase; and the number of documents that contain the second word or phrase but not the first word or phrase.

10. The method of claim 9 wherein the relatedness function is not always symmetric about its first and second word or phrase inputs.

11. The method of claim 9 wherein the relatedness function is the number of documents in the relatedness-analysis collection containing both the first and second words or phrases divided by the number of documents in the relatedness-analysis collection containing the first word or phrase.

12. The method of claim 9 wherein the relatedness function is the number of documents in the relatedness-analysis collection containing both the first and second words or phrases divided by the number of documents in the relatedness-analysis collection containing the first word or phrase but not the second.

13. The method of claim 9 wherein a first word or phrase appearing in the relatedness-analysis collection of documents is determined as being related to a second word or phrase when and only when the value of the relatedness function is greater than a predetermined value.

14. The method of claim 1 wherein the document relevance score for the given word or phrase is zero if the document contains neither the word or phrase nor any of the words or phrases from the predetermined set of words and/or phrases that are related to the given word or phrase.

15. The method of claim 1 wherein the document relevance score is non-zero if the document contains the word or phrase but none of the related words or phrases.

16. The method of claim 9 wherein the document relevance score, if the document does not contain the given word or phrase but does contain at least some of the related words or phrases, is a function of the outputs of the relatedness function indicating how related each related word or phrase appearing in the document is to the given word or phrase.

17. The method of claim 9 wherein the document relevance score, if the document contains the given word or phrase as well as at least one of the related words or phrases, is a function of:
the outputs of the relatedness function indicating how related each related word or phrase appearing in the document is to the given word or phrase; and
the outputs of the relatedness function indicating how related the given word or phrase is to each of the related words and/or phrases appearing in the document.

18. The method of claim 1 further comprising a step of searching for a document from among the source collection of documents by:
receiving a search query comprising at least one word or phrase;
for each document in the source collection of documents, calculating an aforesaid relevance score for the document against a word or phrase of the search query; and
using these relevance scores to determine a most relevant document from the source collection of documents.

19. The method of claim 18 further comprising displaying on a display device one or more selected from the group consisting of: all of the most relevant document; part of the most relevant document; or a reference to the most relevant document; and information concerning the most relevant document.

20. The method of claim 18 further comprising determining a relevant extract from a document by splitting the document into a plurality of blocks, determining a relevance score for text associated with each block against at least one word or phrase of the search query, and further processing the most relevant block.

21. The method of claim 18 comprising determining the most relevant document using additional factors selected from the group consisting of: a document title relevance score; a document body-text relevance score; a domain-name relevance score; a URL relevance score; and a measure of the likelihood that a document containing a given word or phrase is hosted at a given Internet domain extension.

22. The method of claim 18 comprising calculating said relevance score for the document against a plurality of words and/or phrases from the search query.

23. The method of claim 18 comprising determining a list of documents ordered by relevance score or a function of relevance score.

24. The method of claim 1 further comprising determining a thematic-content score for said document as a function of respective relevance scores of the document for each word and phrase from a set of words and phrases occurring in said source collection of documents.

25. The method of claim 24 further comprising determining a thematic-content score for a document sub-collection as a function of the thematic-content scores of every document in the sub-collection.

26. The method of claim 1 further comprising determining a document authority score for a document and a given word or phrase, the authority score being a function of: the relevance of the document to the word or phrase; the relevance, to the word or phrase, of a referring document that contains a reference to the first document; and the relevance, to the word or phrase, of text forming all or part of said reference.

27. The method of claim 26 wherein the authority score is furthermore a function of the total number of references to other documents contained in the referring document.

28. The method of claim 26 wherein the authority score is furthermore a function of the popularity of the referring document.

29. The method of claim 26 wherein the authority score is a function of the relevance scores, to the word or phrase, of every referring documents that contain a reference to the first document; and the relevance scores, to the word or phrase, of respective texts forming all or part of each said reference.

30. The method of claim 1 further comprising identifying a summarising word or phrase for a document by calculating a document relevance score for each word and phrase of a predetermined set of words and phrases, and identifying the word or phrase having the highest relevance score as a summarising word or phrase.

31. The method of claim 30 further comprising displaying or transmitting said summarising word or phrase.

32. The method of claim 30 comprising selecting an advertisement based on said summarising word or phrase, and displaying or transmitting said advertisement.

33. A computer-implemented method of building a database of phrases occurring in a phrase-analysis document collection, comprising, for each of a plurality of sequences of consecutive words:
determining whether, out of all the documents in the phrase-analysis collection that contain all the words of the sequence, the proportion of documents containing the sequence consecutively is greater than a predetermined value; and
including the sequence in the database only if said determination is made.

34. The method of claim 33 comprising, for each of said plurality of sequences of consecutive words:
further determining whether at least one of the words of the sequence is semantically related to all of the other words of the sequence; and
including the sequence in the database only if said further determination is made.

35. The method of claim 33 comprising including the sequence in the database whenever said first and further determinations are both made.

36. The method of claim 33 wherein determining a first word to be semantically related to a second word comprises determining whether, out of all the documents in the phrase-analysis collection that contain the first word, the proportion of documents containing both words is greater than a predetermined value.

37. The method of claim 33 wherein the plurality of sequences of consecutive words comprises all possible sequences of words that are related to one another.

38. The method of claim 1 wherein said predetermined set of words and/or phrases that are related to the given word comprises phrases from a database of phrases built using a computer-implemented method of building a database of phrases occurring in a phrase-analysis document collection, comprising, for each of a plurality of sequences of consecutive words:
determining whether, out of all the documents in the phrase-analysis collection that contain all the words of the sequence, the proportion of documents containing the sequence consecutively is greater than a predetermined value; and
including the sequence in the database only if said determination is made.

39. The method of claim 33 further comprising, for each of a plurality of the documents in the phrase-analysis document collection, parsing the document to generate a tokenised version, in which phrase and words in the document are replaced by tokens.

40. The method of claim 39 wherein said parsing step comprises first replacing all the phrases in the document having length equal to the longest phrase by tokens, then successively replacing phrases shorter by one word until finally replacing any remaining words by tokens.

41. The method of claim 33 further comprising:
receiving a text query comprising one or more words;
for at least one word from the text query, accessing the database to determine a list of phrases starting with that word; and
displaying or transmitting one phrase from the list of phrases.

42. The method of claim 33 further comprising:
receiving a text query;
determining a list of words and phrases related to the text query;
selecting one or more entries from said list of words and phrases; and
displaying or transmitting the selected entry or entries to a user.

43. The method of claim 42 wherein said selected entry or entries is/are the most highly scored word(s) or phrase(s) from said list of related words and phrases according a word and phrase scoring function.

44. Data-processing apparatus for determining the relevance, to a given word or phrase, of a document from a source collection of documents, comprising:
apparatus configured to access a predetermined set of words and/or phrases that are related to the given word or phrase; and
logic configured to calculate a document relevance score as a function of:
whether the word or phrase occurs in the document; and
for each word and phrase from the predetermined set, whether the related word or phrase occurs in the document.

45. Data-processing apparatus for building a database of phrases occurring in a phrase-analysis document collection comprising:
logic configured to determine, for each of a plurality of sequences of consecutive words, whether, out of all the documents in the phrase-analysis collection that contain all the words of the sequence, the proportion of documents containing the sequence consecutively is greater than a predetermined value; and
logic configured to include the sequence in the database only if said determination is made.

46. A machine-readable storage device storing a computer program comprising instructions operable to cause a data-processing apparatus to determine the relevance, to a given word or phrase, of a document from a source collection of documents, by:
accessing a predetermined set of words and/or phrases that are related to the given word or phrase; and
calculating a document relevance score as a function of:
whether the word or phrase occurs in the document; and
for each word and phrase from the predetermined set, whether the related word or phrase occurs in the document.

47. A machine-readable storage device storing a computer program comprising instructions operable to cause a data-processing apparatus to build a database of phrases occurring in a phrase-analysis document collection, by, for each of a plurality of sequences of consecutive words:
determining whether, out of all the documents in the phrase-analysis collection that contain all the words of the sequence, the proportion of documents containing the sequence consecutively is greater than a predetermined value; and
including the sequence in the database only if said determination is made.
